(19) United States
(12) Patent Application Publication
(10) Pub. No.: US 2023/0244775 A1
(43) Pub. Date: Aug. 3, 2023

(54) Verification of Automatic Responses to Authentication Requests on Authorized Mobile Devices

(71) Applicant: salesforce.com, inc., San Francisco, CA (US)

(72) Inventors: Joshua David Alexander, Austin, TX (US); Seth Holloway, Austin, TX (US); Alexa Staudt, Atlanta, GA (US); Ian Michael Glazer, Washington, DC (US); William C. Mortimore, JR., San Francisco, CA (US)

(21) Appl. No.: 17/649,479

(22) Filed: Jan. 31, 2022

(51) Int. Cl. G06F 21/40; G06N 20/00

(52) U.S. Cl. CPC G06F 21/40; G06N 20/00

(57) ABSTRACT

Techniques are disclosed relating to determining risk associated with automated authentication decisions for a multi-factor authentication scheme. In disclosed embodiments, a server system sends requests corresponding to factors in a current multi-factor authentication procedure to a mobile device. The system receives, from the mobile device, automatically generated responses for the factors, where the responses are automatically generated at the mobile device using a machine learning model based on a current set of parameters for the current procedure and a previous set of parameters for a prior procedure. Based on a current state of the mobile device received with the automatically generated responses and prior states of the mobile device stored at the server computer system, the system determines a risk score for the automatically generated responses. Based on the risk score, the system generates an authorization decision for an authorization request corresponding to the current multi-factor authentication procedure.

### BACKGROUND

### Technical Field

Embodiments described herein relate to multi-factor authentication and, in particular, to automating responses, on a mobile device, to one or more authentication requests.

### Description of the Related Art

Security of user information in accessing private accounts or services is an ongoing problem for individuals attempting to access these accounts/services on the internet. Recent multi-factor authentication schemes have increased security for user information. In addition to the traditionally required username and password to be input by the user, multi-factor authentication procedures include an additional factor, e.g., to show that a user is in possession of a known device such as a cell phone.

### BRIEF DESCRIPTION OF THE DRAWINGS

FIGS. 1A and 1B are diagrams illustrating exemplary communication between a mobile device and an authentication server in a multi-factor authentication procedure involving automated authentication decisions based on an unsupervised computer learning process, according to some embodiments.

FIG. 2 is a block diagram illustrating exemplary input parameters to a mobile device from multiple different sources, including environmental parameters and parameters already stored on the mobile device, according to some embodiments.

FIG. 3 is a block diagram illustrating an exemplary computer learning module that is at least partially supervised and that automates authentication decisions based on a target output space, according to some embodiments.

FIG. 4 is a flow diagram illustrating an exemplary method for automating authentication decisions for different accounts without user input, according to some embodiments.

FIG. 5 is a block diagram illustrating exemplary communication during a multi-factor authentication procedure involving verification of automated authentication decisions by the authentication server, according to some embodiments.

FIG. 6 is a flow diagram illustrating an exemplary method for determining risk scores for automated authentication factors received from a mobile device for a multi-factor authentication procedure, according to some embodiments.

FIG. 7 is a block diagram illustrating an exemplary computing device, according to some embodiments.

### DETAILED DESCRIPTION

Multi-factor authentication schemes are often used by online service providers in an attempt to accurately identify account owners and other users of their online services. For example, one factor may relate to knowledge (e.g., user knowledge of a password). Another example factor may relate to possession (e.g., of a device used to receive a separate code out-of-band). Another example factor may relate to inherency (e.g., a property of a device or user). Multiple factors of a given type (e.g., multiple possession factors that are determined using different devices or techniques) may be used for a given multi-factor authentication procedure.

As discussed above, one form of multi-factor authentication involves contacting a secondary computing device (e.g., a mobile device) that the user registers with the account upon new account creation. For example, a user may enter typical account credentials (e.g., user identification and password) into an account sign-in user interface (UI) and if the credentials are valid, the server sends a code (e.g., via a short message service) to the registered mobile device (e.g., a mobile phone, tablet computer, wearable device, or other similar device). In this example, the user reads the code from the mobile device and enters it into the UI of the online service. In some embodiments, the use of multi-factor authentication increases the level of security for a user account/service. However, although multi-factor authentication schemes may increase the level of security for user accounts/services, they may decrease the ease of access for any individual attempting to access one or more private accounts/services.

Therefore, in some embodiments, a computer learning process is used to automate authentication decisions for one or more factors in multi-factor authentication schemes to improve ease of access while maintaining a high level of security for user accounts/services. As one example, a previously authorized mobile device receives a request for a factor in a multi-factor authentication procedure for an account. In this example, without receiving user input concerning automating responses, an unsupervised computer learning module on the previously authorized mobile device automates a response to the authentication request based on multiple different parameters received and/or stored on the mobile device. In some embodiments, a computer learning module implements one of the following to perform various functionality described herein: neural networks, ensemble learning, supervised learning, unsupervised learning, deep learning, machine learning, recursive self-improvement, etc.

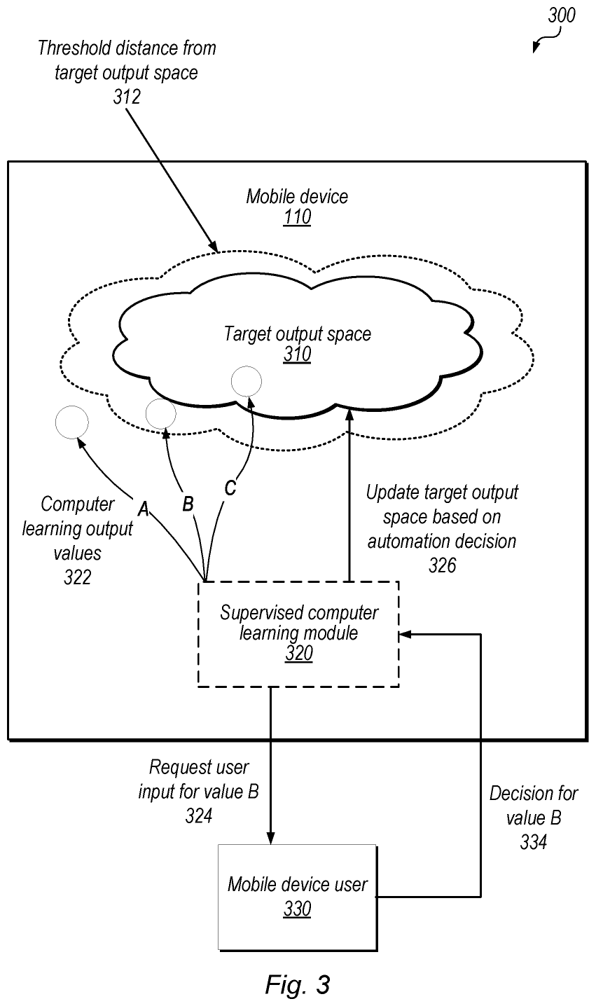

Various embodiments of an unsupervised computer learning module are presented herein. The disclosed embodiments may be used in a stand-alone manner or as one automation method for authentication in a multi-factor authentication scheme in order to provide increased security as well as ease of use over other techniques. The disclosed embodiments may, for example, be combined with other computer learning techniques to provide automation of decisions in multi-factor authentication schemes, including at-least-partially unsupervised techniques that allow for user input in certain scenarios. One example of user input includes decisions for values output from a computer learning module that are within a threshold of a desirable target output space (see FIG. 3 description), which may further allow inclusion of other output values within the threshold in future automation decisions by a computer learning module for multi-factor authentication procedures.

Further, the disclosed embodiments may be used to verify automated authentication responses received from the mobile device for factors in a multi-factor authentication procedure. The disclosed techniques determine an amount of risk associated with mobile device responses for factors in multi-factor authentication procedures either for authorization of a task requested by a user of the mobile device (e.g., user requests to access a secure file via a personal account logged in on their mobile device) or a task requested at one or more other devices (e.g., the same user requests to log into a business account via their desktop computer). These same techniques may be used as a scoring mechanism for determining risk associated with a multi-factor authentication procedures in order to, for example, scale an authentication response to be commensurate with the risk associated with the procedure. For example, the scoring may be performed in response to receiving an automated authentication response from the mobile device to determine both the risk of the automated response as well as the overall risk associated with the authentication procedure that this response was generated for in the first place.

In disclosed techniques, an authentication server executes risk techniques (e.g., comparison over two mobile device states or machine learning) to determine risk for automated authentication responses to determine whether to use factors included in the automated responses for a multi-factor authentication procedure. For example, if a current state of the mobile device matches a known recent prior state of the mobile device, then the automated responses form this device may be trusted and used in a multi-factor authentication procedure. If, however, the two states differ more than a threshold amount, the disclosed techniques may fail the multi-factor authentication procedure and deny an authorization request, escalate the multi-factor authentication procedure (by requiring additional authentication factors), disable machine learning mechanisms used by the mobile device to produce automated responses, etc.

The disclosed techniques may advantageously provide for convenient multi-factor authentication for an end user (e.g., automating responses to factors reduces the amount of user input necessary for authentication), while maintaining hard authentication (e.g., the authentication is difficult to break in terms of fraudulent activity). For example, the disclosed techniques allow for automation of responses to authentication factors while still verifying the safety of such automated responses during a multi-factor authentication process.

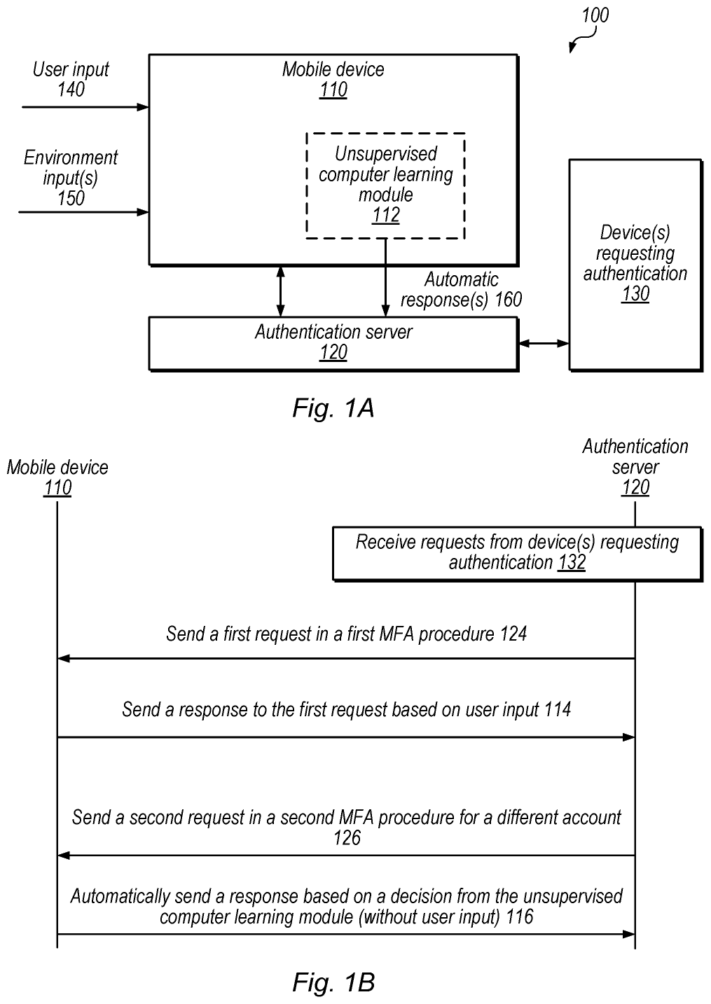

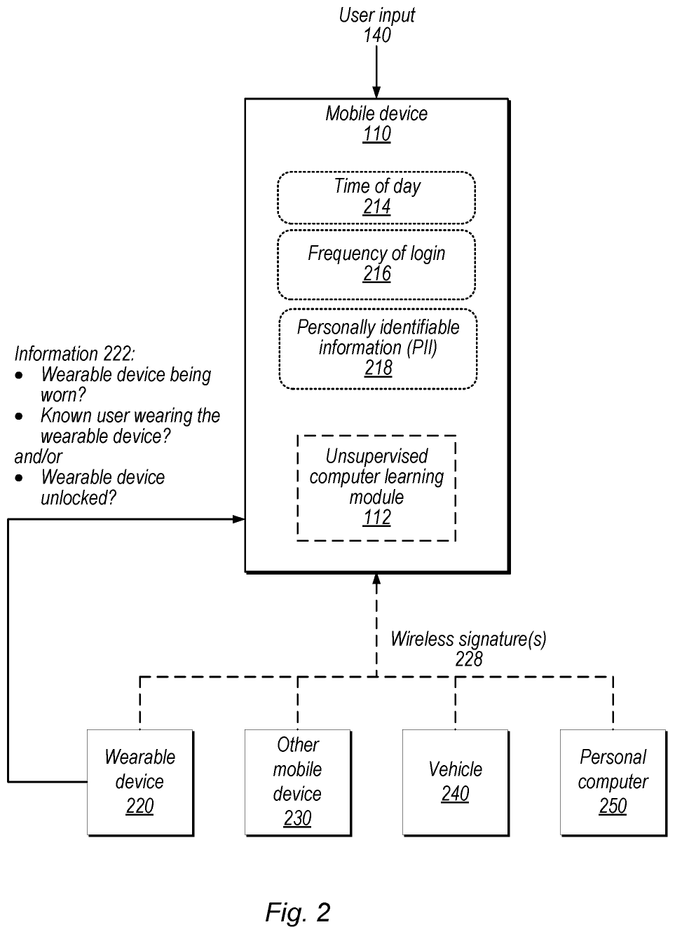

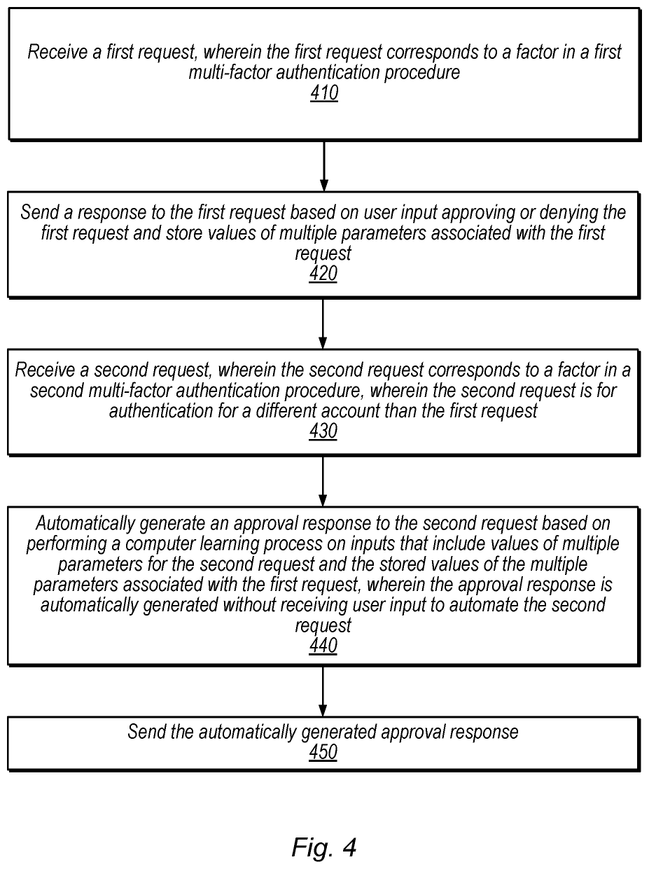

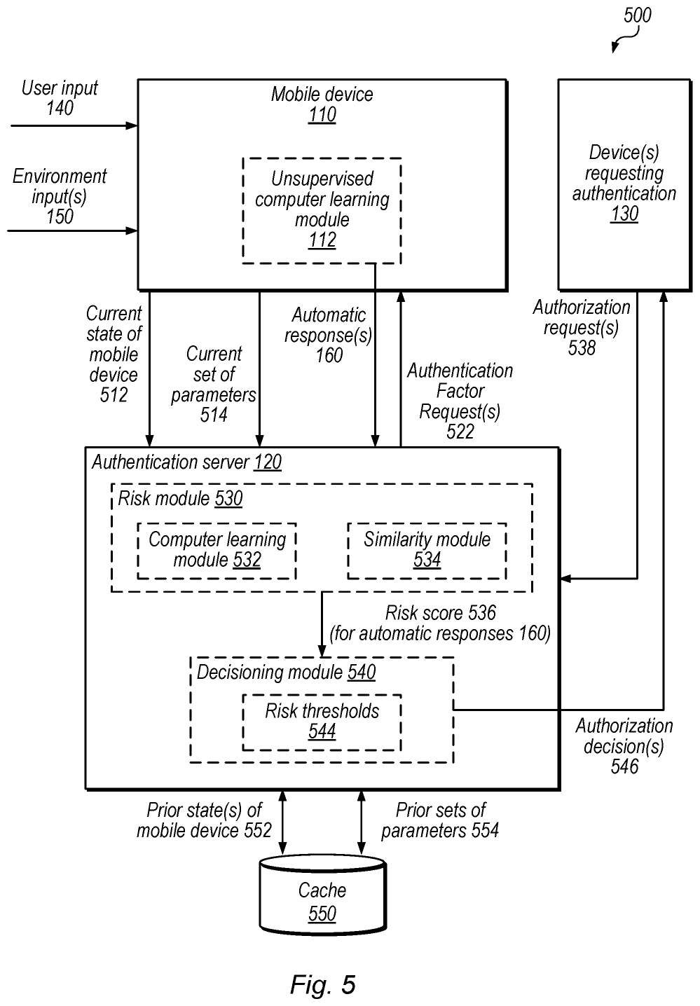

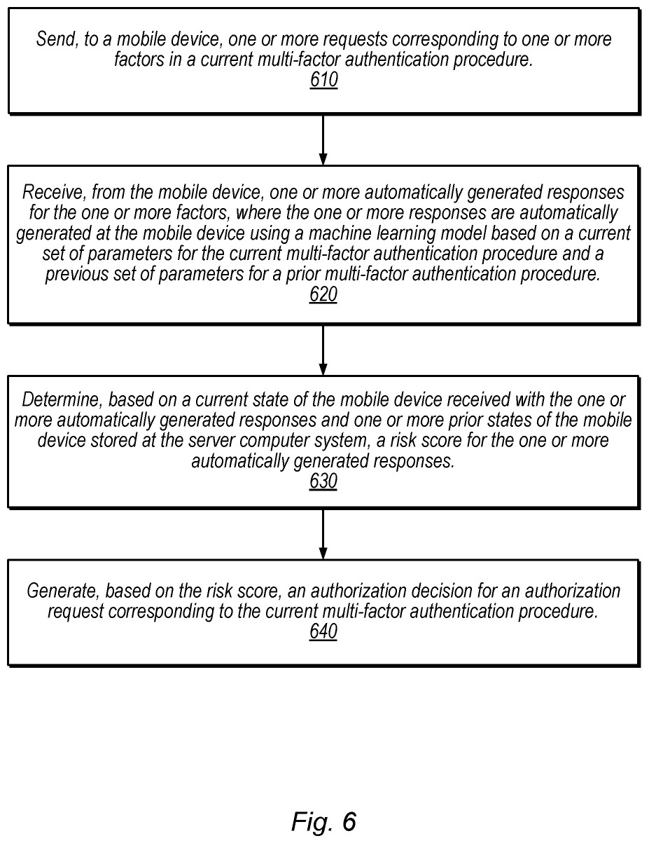

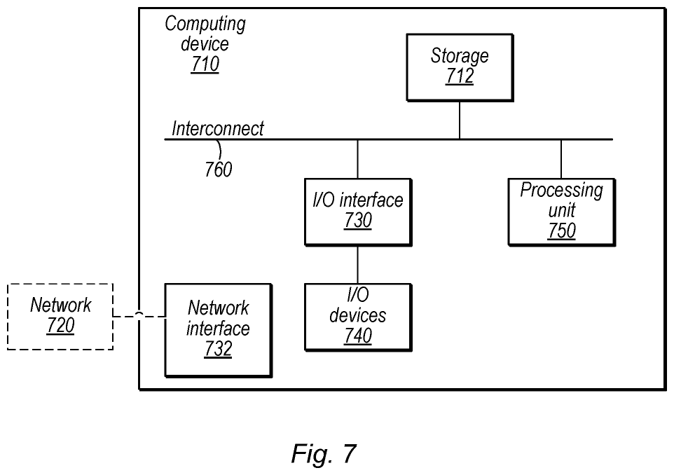

This disclosure initially describes, with reference to FIG. 1, exemplary automation of authentication decisions in multi-factor authentication schemes. Input parameters to a mobile device are discussed with reference to FIG. 2. FIG. 3 shows an embodiment of a supervised computer learning module. FIG. 5 shows an embodiment of automated authentication decisions involving trust threshold. FIGS. 4 and 6 illustrate exemplary methods and FIG. 7 shows an exemplary computing device.

### Example Authentication Server

FIGS. 1A and 1B are diagrams illustrating exemplary communication between a mobile device and an authentication server in a multi-factor authentication procedure involving automated authentication decisions based on an unsupervised computer learning process. In the illustrated embodiment, system 100 includes mobile device 110, authentication server 120 and devices 130.

In FIG. 1A, mobile device 110 receives user input 140 and environment input(s) 150. The user input 140 received by the mobile device 110 may include but is not limited to one or more of the following: application activity, short message service (SMS) messaging activity, frequency of login, unlock information (e.g., a passcode, biometric information, etc.), and/or other personally identifiable information (PII). Environmental input may include, but is not limited to one or more of the following: time of day, proximity to other devices, biometric information from a wearable device, known user wearing a wearable device, whether a wearable device is unlocked, location of mobile device 110, location of devices in proximity to the mobile device 110, etc.

In the illustrated embodiment, one or more devices 130 request authentication of a user from authentication server 120 (e.g., based on a user attempting to access an account on one of the devices) and the authentication server 120 communicates with mobile device 110 for a factor in the multi-factor authentication process for the user. In the illustrated embodiment, mobile device 110 includes unsupervised computer learning module 112. In the illustrated embodiment, the unsupervised computer learning module 112 determines whether to send automatic response(s) 160 to authentication server 120. (Note that the user may be prompted for a response in instances where module 112 does not provide an automatic response). In some embodiments, the unsupervised computer learning module stores parameter values based on user input 140 and/or environmental input(s) 150. In some embodiments, the parameter values may be stored in a processed format. In some embodiments, module 112 sends automatic response(s) 160 to authentication server based on past and/or current parameter values corresponding to one or more inputs 140 and/or input(s) 150. Based on responses from mobile device 110 (and/or a device 130), the authentication server 120 may authenticate the user.

As used herein, the term “unsupervised computer learning” refers to situations where the user of a mobile device does not indicate to automate decisions or indicate whether unsupervised decisions made by the computer learning process are correct or not. That is, in some embodiments, the unsupervised computer learning process learns when to automate on its own, without user input. One example of unsupervised computer learning involves the module clustering groups of one or more parameters (e.g., frequency of login, wireless signatures, etc.) based on an association with a valid user logging into one or more accounts. In some embodiments, the unsupervised computer learning module on one or more mobile devices becomes unique to the mobile device it is stored on due to training based on different values for various input parameters to the one or more mobile devices. In some embodiments, the learning module may be transferred to another device, e.g., when the user upgrades their mobile phone. In some embodiments, the entire process from receiving a request from the authentication server 120 to sending an automated response from the mobile device 110 is unsupervised.

In some embodiments, all or a portion of the unsupervised computer learning module is implemented as program code stored on a secure circuit. A secure circuit may limit the number of ways that the stored program code may be accessed (e.g., by requiring a secure mailbox mechanism). Examples of secure circuits include the secure enclave processor (SEP) and the trusted execution environment (TEE) processor. In some embodiments, an SEP or a TEE processor is used to store data securely, e.g., by encrypting stored data and by limiting access to itself (e.g., the SEP or TEE processor are isolated from the main processor on the mobile device).

FIG. 1B is a communications diagram illustrating exemplary messages between the authentication server 120 and mobile device 110. At 132, in the illustrated embodiment, authentication server 120 receives requests from one or more devices requesting authentication in order to access an account. In some embodiments, the requests received at block 132 are from mobile device 110 (e.g., device 130 and device 110 may be the same device). At 124, in the illustrated embodiment, authentication server 120 sends a first request in a first multi-factor authentication procedure. At 114, in the illustrated embodiment, mobile device 110 sends a response to the first request based on user input. In some embodiments, the response at 114 does not include user input specifying whether to automate future authentication requests.

At 126, in the illustrated embodiment, authentication server 120 sends a second request in a second multi-factor authentication procedure to mobile device 110. In some embodiments, the request sent at 126 is for authentication of the user for a different account than the request sent at 124. At 116, in the illustrated embodiment, mobile device 110 automatically sends a response to authentication server 120 based on a decision from the unsupervised computer learning module, without requesting or receiving any user input associated with the second request.

In some embodiments, the request that is being automated on the mobile device 110 is for two different accounts. In some embodiments, the two different accounts (e.g., account A and account B) are for two different services (e.g., an email service and an online shopping service). In some embodiments, the two different accounts (e.g., a personal account and a business account) are for the same service (e.g., an email service). In some embodiments, two different requests, for which at least one response is automated on the mobile device 110, are for the same account and for the same service.

Various techniques for automating responses for factors in multi-factor authentication schemes are discussed in previously filed U.S. patent application Ser. No. 14/849,312, filed on Sep. 9, 2015. In the previously filed application, automating authentication decisions is performed after user input is received indicating that future authentication decisions should be automated. In disclosed embodiments, a computer learning process is used to automate decisions for one or more factors in multi-factor authentication schemes without receiving any input from a user regarding automation. Further, in disclosed embodiments, an unsupervised computer learning process is used to automate authentication decisions on a mobile device for different accounts/services that the user of the mobile device is attempting to login to/access.

In this disclosure, various “modules” operable to perform designated functions are shown in the figures and described in detail (e.g., unsupervised computer learning module 112, risk module 530, decisioning module 540, etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC.

### Example Parameters

FIG. 2 is a block diagram illustrating exemplary input parameters to a mobile device from multiple different sources, including environmental parameters and parameters already stored on the mobile device. In the illustrated embodiment, mobile device 110 receives user input 140 and information from wearable device 220, other mobile device 230, vehicle 240, and personal computer 250.

Mobile device 110, in the illustrated embodiment, stores values for the following parameters: time of day 214, frequency of login 216, and personally identifiable information (PII) 218. In some embodiments, time of day 214 is received in one or more formats (e.g., a different time zone depending on location, 24-hour time, coordinated universal time (UTC), etc.). In some embodiments, frequency of login 216 information includes the number of times the mobile device user logs into: the mobile device, one or more applications, one or more accounts, one or more services, a set of multiple different accounts, etc. In some embodiments, the frequency of login 216 is related to the time of day 214. For example, in some embodiments, the frequency of login 216 information is determined for specified time intervals (e.g., 10 am to 2 pm), for certain days in a week (e.g., only weekdays), over multiple intervals of different lengths (e.g., the last hour or three hours), etc. In some embodiments, PII 218 includes information such as the user's: name, date of birth, biometric records, relatives' names, medical information, employment history, etc. In some embodiments, PII 218 is stored on mobile device 110 and is not available to authentication server 120. In these embodiments, automating decisions based on this information at the mobile device may improve automation accuracy, relative to automation techniques at authentication server 120.

In some embodiments, parameters 214, 216, and 218 are stored internally on mobile device 110 in the format they are received or determined. In some embodiments, processed values (e.g., vectors) may be stored based on these parameters, e.g., after processing by module 112.

As discussed above, certain PII may not be available on the server side. Including PII from the mobile device 110 in server-side authentication decisions would require sending this information from the mobile device to the authentication server 120. This may be undesirable because of the sensitivity of such information and because of regulation. For example, data privacy regulations may specify that PII should not be transmitted to any other computing devices (e.g., the information must remain on the device it originated from). Therefore, it may be advantageous to keep PII securely stored on device 110 to comply with such regulations. Therefore, in some disclosed embodiments, automation decisions are made on mobile device 110. In these embodiments, PII 218 values may never leave mobile device 110 and are used by unsupervised computer learning module 112 in automating authentication decisions.

In the illustrated embodiment, mobile device 110 receives information 222 from wearable device 220. In the illustrated embodiment, information 222 indicates whether device 220 is currently being worn. In addition, in the illustrated embodiment, information 222 indicates whether a known user (e.g., the user of the mobile device 110) is wearing device 220. In the illustrated embodiment, information 222 indicates whether or not device 220 is unlocked. In various embodiments, any combination of the three sets of information contained in information 222 from wearable device 220 may be stored on mobile device 110 and processed by module 112. Although three status indicators are shown in information 222 for purposes of illustration, one or more of these indicators may be omitted and/or other indicators may be included. The illustrated examples of information from wearable device 220 are not intended to limit the scope of the present disclosure.

In the illustrated embodiment, mobile device 110 receives wireless signature(s) 228 from devices 220 and 230, vehicle 240, and personal computer 250. In some embodiments, a wireless signature from one or more of these sources is a Bluetooth low energy (BLE) signature, a WLAN signature, a cellular signature, or a near-field communication (NFC) signature. A wireless signature may include information that is detectable before and/or after connecting with a corresponding device. Further, a wireless signature may include information that is intentionally transmitted by the corresponding device (e.g., a transmitted identifier such as a MAC address) and other types of information (e.g., wireless characteristics of the device related to its physical configuration). In some embodiments, BLE beacon devices transmit a universally unique identifier that informs mobile device 110 that one or more devices are nearby, without connecting, e.g., through BLE, to these devices. In some embodiments, NFC signatures involve short-range radio waves that allow mobile device 110 to determine that another NFC device is a short distance away.

In some embodiments, a wireless signature from a personal computer 250 informs mobile device 110 that it is at the residence of the user (e.g., the mobile device is nearby their desktop PC which is inside their residence). In some embodiments, a wireless signature 228 from vehicle 240 informs mobile device 110 that it is near vehicle 240, which may be an indicator that the device has not been stolen. In some embodiments, a wireless signature 228 from other mobile device 230 informs mobile device 110 that it is near another commonly used device (e.g., if device 230 is a tablet owned by the user of mobile device 110). In various embodiments, the values of wireless signatures from one or more devices are used by a computer learning module to determine whether to automate one or more authentication decisions in a multi-factor authentication procedure. In disclosed embodiments, mobile device 110 may not know the type or identification of a device whose signature it recognizes, but may simply recognize whether the signature is present or not during authenticating procedures, which may be used as an automation criterion. In some embodiments, if mobile device 110 detects wireless signatures from multiple known devices at the same time (e.g., from wearable device 220 and vehicle 240), the unsupervised computer learning module 112 may be more likely to automate authentication decisions.

Example with Partially Supervised Computer Learning Module

Various embodiments of an unsupervised computer learning process are discussed above. However, as noted above, unsupervised computer learning techniques may be combined with other computer learning techniques to provide automation decisions in multi-factor authentication schemes. In particular, a user may be asked for inputs in certain circumstances where automation should likely be performed but cannot be determined with a threshold degree of certainty. In some embodiments, the system requests input from a user for certain values output from the unsupervised computer learning module that are within a threshold distance from a desirable target output space.

In some embodiments, a multi-factor authentication procedure uses an unsupervised computer learning mode in automating authentication decisions for the entire procedure. However, in some embodiments, automation for a multi-factor authentication procedure reverts to a supervised mode in certain circumstances (e.g., for uncertain output values).

FIG. 3 is a block diagram illustrating an exemplary supervised computer learning module that automates authentication decisions based on a target output space. In the illustrated embodiment, system 300 includes mobile device 110 and mobile device user 330.

In the illustrated embodiment, mobile device 110 includes supervised computer learning module 320 with target output space 310. In the illustrated embodiment, target output space 310 is shown outside of module 320 for discussion purposes. However, in some embodiments, the dimensions of target output space 310 are stored inside module 320 and module 320 checks outputs internally. Note that output space 310 may be a multi-dimension space and module 320 may output a vector in the space. This type of output may be typical for neural networks, for example, but similar techniques may be used for other types of computer learning algorithms with different types of outputs. The embodiment of FIG. 3 is shown for purposes of illustration and is not intended to limit the type of computer learning used in other embodiments.

In the illustrated embodiment, supervised computer learning module 320 outputs values 322 (i.e., values A, B, and C) based on the automation parameter values received from mobile device 110. In some embodiments, supervised computer learning module 320 evaluates values 322 as they relate to target output space 310. At 312, in the illustrated embodiment, the dotted outline represents a threshold distance from the target output space 310. In the illustrated embodiment, value A is outside space 310, value B is within a threshold distance from space 310, and value C is inside space 310.

At 324, in the illustrated embodiment, supervised computer learning module 320 sends a request to mobile device user 330 for input concerning computer learning output value B. At 334, in the illustrated embodiment, user 330 sends a decision to module 320 for value B. In the illustrated embodiment, at 326, module 320 updates the target output space 310 based on the decision for value B received at 334 from mobile device user 330. Note that the decision 334 may not include input from the user for future automation but may only include a decision for one particular value as requested by module 320.

In some embodiments supervised computer learning techniques may be implemented, in addition to or in place of the unsupervised techniques discussed herein. In some embodiments, supervised computer learning involves a set of “training” values. For example, a supervised computer learning module is provided a predetermined set of values for which the correct outputs are known. In this example, based on those values, the supervised computer learning process generates outputs and compares them with the set of training values. If the generated outputs match the training outputs (e.g., a direct match or within some threshold), the supervised computer learning process may be considered trained (although additional training may continue afterwards). If the values are different, the supervised computer learning process adjusts one or more internal parameters (e.g., adjusting weights of neural network nodes, adjust rules of a rule-based algorithm, etc.). Note that the adjustments to target output space 310 discussed above are supervised in the sense that user input is required, but does not actually result in training of module 320, but merely adjusting target outputs. In other embodiments, user input may be used to train module 320 in a supervised fashion.

### Exemplary Method

FIG. 4 illustrates an exemplary method for automating authentication decisions for different accounts without user input, according to some embodiments. The method shown in FIG. 4 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 410, in the illustrated embodiment, a mobile phone receives a first request, where the first request corresponds to a factor in a first multi-factor authentication procedure.

At 420, in the illustrated embodiment, the mobile device sends a response to the first request based on user input approving or denying the first request and stores values of multiple parameters associated with the first request.

At 430, in the illustrated embodiment, the mobile device receives a second request, where the second request corresponds to a factor in a second multi-factor authentication procedure, where the second request is for authentication for a different account than the first request. In some embodiments, the different account for the second request is for a different service than the account for the first request.

At 440, in the illustrated embodiment, an unsupervised computer learning module on the mobile device automatically generates an approval response to the second request based on performing a computer learning process on inputs that include values of multiple parameters for the second request and the stored values of the multiple parameters associated with the first request, where the approval response is automatically generated without receiving user input to automate the second request. In some embodiments, the multiple parameters include a frequency of login parameter that indicates how often the user of the mobile device logs into a set of one or more accounts. In some embodiments, the multiple parameters include a wearable device parameter that indicates whether a wearable device is being worn by the user of the mobile device and whether the wearable device is unlocked. In some embodiments, the multiple parameters include one or more parameters that indicate personally identifiable information (PII) that is stored on the mobile device that is not shared with other devices. In some embodiments, the multiple parameters include a wireless signature parameter based on wireless signatures of one or more nearby devices. In some embodiments, the computer learning process is an unsupervised computer learning process. In some embodiments, the wireless signature is a Bluetooth Low Energy (BLE) signature. In some embodiments, program code for the computer learning process is stored on a secure circuit.

In some embodiments, the computer learning process outputs one or more values and a determination whether to automate is based on whether one or more values output from the computer learning process are in a target output space. In some embodiments, the computer learning process requests user input indicating whether or not to automate in response to determining that the one or more values are outside the target output space but within a threshold distance from the target output space. In some embodiments, the computer learning process updates the target output space in response to the user selecting to automate. In other embodiments, the computer learning process may train itself based on explicit user input.

At 450, in the illustrated embodiment, the mobile device sends the automatically generated approval response. In some embodiments, an authorization decision is based at least in part on detecting close proximity or physical contact of one or more devices, e.g., using short-range wireless technology. In some embodiments, the short-range wireless technology is near-field communication (NFC). In some embodiments, short-range wireless technology is used for one or more factors in a multi-factor authentication process. In a multi-factor authentication procedure, a factor relating to possession and intentionality (possession of one or more of the devices in short-range communication and intention to move the devices near each other) may be used as an additional factor to knowledge (e.g., of a username and password) and possession (e.g., using the automated techniques discussed herein), in various embodiments. This example embodiment may be referred to as three-factor authentication (e.g., with two possession-related factors and one knowledge-related factor) or two-factor authentication (e.g., grouping the intentional and automated possession techniques as a single factor).

A short-range wireless device may be embedded in a user's clothing, for example. In this example, upon receiving a request for a factor in a multi-factor authentication process, the user taps the mobile device against their short-range wireless enabled clothing. The device may provide limited-use passcodes or other identifying data that the mobile device then provides to the authentication server. The authentication server may, in certain scenarios, authenticate only if this short-range wireless exchange is confirmed. In this example, the user is intentionally employing short-range wireless technology for a factor (e.g., a possession factor) in a multi-factor authentication procedure.

In some embodiments, using short-range wireless technology in a multi-factor authentication procedure advantageously improves the level of security for certain high-security transactions. Note that short-range wireless technology may be used for a factor even when disclosed automation techniques are not involved (e.g., user input is received for the factor) in a multi-factor authentication procedure. However, in some embodiments, short-range wireless communications (e.g., NFC-enabled clothing) are used as another input parameter to the computer learning process.

FIG. 5 is a block diagram illustrating exemplary communication during a multi-factor authentication procedure involving verification of automated authentication decisions by an authentication server. In the illustrated embodiment, system 500 includes mobile device 110, computing device(s) 130 requesting authentication, cache 550, and authentication server 120, which in turn includes risk module 530 and decisioning module 540. Cache 550 may be implemented using any of various storage mechanisms including a non-relational database such as a key-value database, a document data store, a column-oriented database, or any of various types of relational databases.

Authentication server 120, in the illustrated embodiment, receives authorization requests 538 from one or more computing devices 130. For example, a user of mobile device 110 may use a wearable device (one example of device 130) to request access to initiate a transaction via their business account logged in on device 130. Based on an authorization request 538 received from a computing device 130, authentication server 120 sends one or more requests 522 for factors in a multi-factor authentication procedure to mobile device 110.

As discussed above with reference to FIG. 1, mobile device 110 automatically generates one or more responses for the requested authentication factors using unsupervised computer learning module 112 and transmits these responses 160 to authentication server 120. In addition to transmitting one or more automatic responses 160, mobile device 110 sends a current state 512 of mobile device and a current set 514 of parameters for the current multi-factor authentication procedure (corresponding to authentication factor request(s) 522) to authentication server 120. The current set 514 of parameters includes environment input(s) 150, which may include values for any of the various parameters discussed above with reference to FIG. 2, including time of day 214, frequency of login 216, PII 218, information 222, etc. The current state 512 of the mobile device 110 includes values for any of the various parameters included in the current set 514 of parameters as well as values for one or more of the following parameters: a location (city, state, country, etc.) of the mobile device 110, an IP address of the mobile device 110, whether the mobile device 110 is logged into a virtual private network (VPN), etc. In some embodiments, authentication server 120 adds values for various account parameters associated with an account currently logged in on mobile device 110, such as permissions (data, locations, doors, etc. allowed to be accessed) for the account currently logged in, profile information for the account currently logged in, resources previously accessed by this device (e.g., secure documents, files, doors, buildings, etc.), risk scores for a current multi-factor authentication procedure (risk score for the requested authorization as well as risk scores for the automatic response(s) 160), etc.

In the illustrated embodiment, authentication server 120 executes risk module 530 to determine risk score(s) 536 for the automatic response(s) 160. Prior to executing risk module 530, authentication server 120 retrieves one or more prior states 552 of mobile device and one or more prior sets of parameters 554 from cache 550. The prior states 552 of mobile device 110 include historical activity of the mobile device 110 during prior multi-factor authentication procedures, such as prior risk scores for automatic responses associated with these prior procedures initiated by this device, or by device(s) 130.

In some embodiments, risk module 530 executes a machine learning module 532 to determine risk scores 536. For example, risk module 530 inputs a current state 512 of mobile device 110 into machine learning module 532 which outputs classifications for one or more automatic responses 160. Machine learning module 532 may be any of various types of classification models including linear classifiers, logistic regression classifiers, Naïve Bayes classifiers, support vector machines, neural networks, decision trees, etc. Machine learning module 532 is trained by authentication server 120 (or another server) using prior states 552 of mobile device 110. In some embodiments, server 120 trains machine learning module 532 using prior states 552 of the mobile device retrieved from the past 30, 60, 90, etc. days. In this way, machine learning module 532 is trained to recognize an average state of the mobile device during the past, e.g., 30 days. The average state of the mobile device for a given prior time interval may be considered the normal or baseline state of the mobile device. For example, an average state may indicate that the mobile device has not been compromised in some way (e.g., stolen). Once trained, the machine learning module 532 is able to identify if a current state of the mobile device deviates from the average or “healthy” state of the mobile device. Authentication server 120 continually trains machine learning module 532 using a rolling window of most recent prior states for the mobile device 110. For example, at the end of each day, authentication server 120 may train module 532 using prior mobile device states from a time interval that is slid one day forward (e.g., the interval window is switched from January 1^{st}-January 30^{th} to January 2^{nd}-January 31^{st}).

In some embodiments, risk module 530 determines risk scores 536 for automatic response(s) 160 by comparing a current state 512 of mobile device 110 with one or more prior states 552 of the mobile device 110. As discussed above with reference to the machine learning module 532 embodiment, an average or healthy state of the mobile device may be determined from multiple prior states. For example, the risk module 530 may plot values for parameters included in multiple prior states of the mobile device and then calculate an average state from these values to be used for comparison with a current state of the mobile device. In some situations, risk module 530 may determine an average or baseline state for the mobile device during two different periods. For example, risk module 530 may determine two different average prior states for the mobile device: one based on the past two years of data and one for the past month of data.

Based on comparing a current state to one or more prior states (or a prior average state), risk module 530 determines a similarity value for the current state and the one or more prior states. Risk module 530 then assigns a risk score to the automatic response(s) 160 based on the similarity value. For example, risk module 530 may include a similarity module 534 executable to determine risk based on differences between the current and prior states of the mobile device. In this example, the similarity module 534 may include similarity thresholds. Further in this example, if the similarity value determined by risk module 530 satisfies a low similarity threshold (e.g., is below a certain value), then the risk score assigned to the automatic response(s) 160 by risk module 530 may be associated with high risk and vice versa.

In various embodiments, risk module 530 determines a risk score 536 based further on a current authorization request 538. For example, when inputting a current state 512 of the mobile device into the machine learning module 532, risk module 530 includes authorization request 538. For example, the authorization request may be a user of a computing device 130 requesting to: access a secure document, log into a work account, access production code, open a door in a bank, initiate an online transaction, etc. The authorization request 538 itself is considered as part of the risk mechanism executed by authentication server 120. In this way, if a user is requesting to access classified documents, automatic responses 160 generated by mobile device 110 may be disabled; whereas, if the user is requesting to log in to their work account using the correct username and password, automatic responses 160 may be accepted by authentication server 120.

Risk module 530, in the illustrated embodiment, sends a risk score 536 for automatic response(s) 160 to decisioning module 540. Decisioning module 540, in the illustrated embodiment, includes risk thresholds 544. Risk thresholds 544 are associated with different actions. For example, if risk score 536 satisfies a first risk threshold, decisioning module 540 generates an authorization decision 546 that approves an authorization request 538 received from a computing device 130. As another example, if risk score 536 satisfies a second risk threshold, decisioning module 540 generates an authorization decision 546 initiating additional factors to be sent to mobile device 110 (or device 130) for authentication. The additional factors may require manual authentication i.e., user input for the factors, such as facial recognition, a personal identification number (PIN), etc. instead of automation by unsupervised machine learning module 112). In this example, the authentication server 120 may require multiple additional factors to be submitted simultaneously based on the risk score 536 satisfying the second risk threshold. For example, both the user of mobile device as well as a manager of the user must provide authentication factors within a certain amount of time after these factors are requested by authentication server 120. In this example, the intentional conflation of authentication (use proving who they are with a factor) and authorization (the manager needs to approve the user's request) provides additional security in situations in which the automatic responses 160 (and by extension the multi-factor authentication procedure) have been identified as risky by risk module 530.

As yet another example, if risk score 536 satisfies a third risk threshold, decisioning module 540 generates an authorization decision 546 terminating execution of unsupervised computer learning module 112 for future multi-factor authentication procedures. In a further example, if risk score 536 satisfies a fourth risk threshold, decisioning module 540 generates an authorization decision 546 rejecting the authorization request.

In the illustrated embodiment, authentication server 120 transmits one or more authorization decisions 546 generated by decisioning module 540 for one or more authorization requests 538. After generating an authorization decision for a given request 538, authentication server 120 stores the current state 512 of the mobile device in cache 550 for use in evaluating future automatic responses 160 for future multi-factor authentication procedures.

In various situations, the techniques discussed with reference to FIG. 5 may be used to determine risk associated with automatic responses generated in multi-factor authentication procedures. In one specific example, if the prior states of a mobile device indicate that a user does not generally travel to San Francisco, but is currently attempting to log in to their account via their mobile device from this city, the risk score for automatic responses generated for this log in authentication request may indicate higher risk than if the user were attempting to log in to their account via their mobile device in their home city. In this specific example, the mobile device is operating outside of its “normal” circumstances and, as such, the disclosed authentication server may act to block automated authentication on the mobile device or may escalate authentication requirements for this device (or the account logged in on this device).

In various embodiments, the disclosed techniques evaluate automated authentication factors for a multi-factor authentication procedure and determine, based on the evaluation, whether to escalate the multi-factor authentication procedure. In some embodiments, one mobile device may be associated with a higher tolerance for risk than another device. For example, if a first user consistently travels to new locations for work, then their mobile device's “average state” is highly variable in comparison with a second user that works from home and does not travel regularly. As a result, risk module 530 may allow the mobile device of the first user to keep utilizing unsupervised computer learning to generate automatic responses 160 even if its current state is highly variable from a most recent prior state (i.e., since the normal state for this device various greatly over the past 40 days), but does not allow the mobile device of the second user to utilize unsupervised learning if its most recent state is dissimilar to its most recent prior state.

FIG. 6 illustrates an exemplary method for determining risk scores for automated authentication factors received from a mobile device for a multi-factor authentication procedure, according to some embodiments. The method shown in FIG. 6 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, the elements of method 600 are performed by authentication server 120 (shown in both FIG. 1 and FIG. 5).

At 610, in the illustrated embodiment, a server computer system sends one or more requests corresponding to one or more factors in a current multi-factor authentication procedure to a mobile device. In some embodiments, the one or more requests corresponding to the one or more factors are sent to the mobile device based on receiving a response from the mobile device approving or denying a first request in a first multi-factor authentication procedure initiated by the mobile device for a first account. In some embodiments, the multi-factor authentication procedure is initiated by another computing device for authentication for a different account than the first account.

At 620, in the illustrated embodiment, the server computer system receives, from the mobile device, one or more automatically generated responses for the one or more factors. In some embodiments, the one or more responses are automatically generated at the mobile device using a machine learning model based on a current set of parameters for the current multi-factor authentication procedure and a previous set of parameters for a prior multi-factor authentication procedure. In some embodiments, the one or more automatic responses received from the mobile device are received for an authorization requested by the mobile device.

At 630, in the illustrated embodiment, the server computer system determines, based on a current state of the mobile device received with the one or more automatically generated responses and one or more prior states of the mobile device stored at the server computer system, a risk score for the one or more automatically generated responses. In some embodiments, determining the risk score is performed by inputting the current state of the mobile device into a computer learning model stored at the server computer system. In some embodiments, the computer learning model is an unsupervised machine learning model. In some embodiments, determining the risk score includes determining a similarity value based on comparing the current state of the mobile device and the one or more prior states of the mobile device. In some embodiments, determining the risk score includes assigning, based on the similarity value, a risk score to the one or more automatically generated responses. In some embodiments, determining the risk score is performed by inputting the current state of the mobile device into a machine learning model stored at the system, where the machine learning model is trained at the system using one or more prior states of the mobile device gathered for one or more prior multi-factor authentication procedures during a particular prior interval of time during a particular prior interval of time.

In some embodiments, the prior state of the mobile device and the current state of the mobile device include respective values for types of parameters included in the current set of parameters. In some embodiments, the prior state of the mobile device and the current state of the mobile device further include respective values for one or more of the following types of mobile device parameters: a location, an IP address, and permissions for an account currently logged in on the mobile device. In some embodiments, the current set of parameters and the previous set of parameters include respective values one or more of the following types of parameters: a frequency of login parameter that indicates how often a user of the mobile device logs into a set of one or more accounts and a wearable device parameter that indicates whether a wearable device is being worn by the user of the mobile device and whether the wearable device is unlocked. In some embodiments, the current set of parameters and previous set of parameters include respective values one or more of the following types of parameters: one or more parameters that indicate personally identifiable information (PII) that is stored on the mobile device that is not shared with other devices, and a wireless signature parameter based on wireless signatures of one or more nearby devices.

At 640, in the illustrated embodiment, the server computer system generates, based on the risk score, an authorization decision for an authorization request corresponding to the current multi-factor authentication procedure. In some embodiments, generating the authorization decision is further based on comparing the risk score to a plurality of risk thresholds. In some embodiments, generating the authorization decision is further based on determining, based on the risk score satisfying a particular risk threshold, whether to escalate the multi-factor authentication procedure.

In some embodiments, the authorization decision indicates, based on the risk score satisfying a particular risk threshold, to disable automated generation of multi-factor authentication responses performed on the mobile device using the machine learning model. In some embodiments, the authorization decision indicates to deny the authorization request corresponding to the multi-factor authentication procedure based on the risk score satisfying a particular risk threshold. In some embodiments, the authorization decision indicates to transmit, to a system administrator of a risk system, a notification regarding the authorization request, including the risk score for the authorization request based on the risk score satisfying a particular risk threshold. In some embodiments, the authorization decision indicates, based on the risk score satisfying a particular risk threshold, to require, by the mobile computing device, authentication of an additional factor in the current multi-factor authentication procedure.

### Exemplary Computing Device

Turning now to FIG. 7, a block diagram of a computing device (which may also be referred to as a computing system) 710 is depicted, according to some embodiments. Computing device 710 may be used to implement various portions of this disclosure. Computing device 710 is one example of a device that may be used as a mobile device, a server computer system, a client computer system, or any other computing system implementing portions of this disclosure.

Computing device 710 may be any suitable type of device, including, but not limited to, a personal computer system, desktop computer, laptop or notebook computer, mobile phone, mainframe computer system, web server, workstation, or network computer. As shown, computing device 710 includes processing unit 750, storage subsystem 712, and input/output (I/O) interface 730 coupled via interconnect 760 (e.g., a system bus). I/O interface 730 may be coupled to one or more I/O devices 740. Computing device 710 further includes network interface 732, which may be coupled to network 720 for communications with, for example, other computing devices.

Processing unit 750 includes one or more processors, and in some embodiments, includes one or more coprocessor units. In some embodiments, multiple instances of processing unit 750 may be coupled to interconnect 760. Processing unit 750 (or each processor within processing unit 750) may contain a cache or other form of on-board memory. In some embodiments, processing unit 750 may be implemented as a general-purpose processing unit, and in other embodiments it may be implemented as a special purpose processing unit (e.g., an ASIC). In general, computing device 710 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions or computer instructions from any suitable form of non-transitory computer-readable media to perform specified operations.

Storage subsystem 712 is usable by processing unit 750 (e.g., to store instructions executable by and data used by processing unit 750). Storage subsystem 712 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 712 may consist solely of volatile memory in some embodiments. Storage subsystem 712 may store program instructions executable by computing device 710 using processing unit 750, including program instructions executable to cause computing device 710 to implement the various techniques disclosed herein.

I/O interface 730 may represent one or more interfaces and may be any of various types of interfaces configured to couple to and communicate with other devices, according to various embodiments. In some embodiments, I/O interface 730 is a bridge chip from a front-side to one or more back-side buses. I/O interface 730 may be coupled to one or more I/O devices 740 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

It is noted that the computing device of FIG. 7 is one embodiment for demonstrating disclosed concepts. In other embodiments, various aspects of the computing device may be different. For example, in some embodiments, additional components, or multiple instances of the illustrated components may be included.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function.

This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A non-transitory computer-readable medium having instructions stored thereon that are capable of execution by a server computer system to perform operations comprising:
sending, to a mobile device, one or more requests corresponding to one or more factors in a current multi-factor authentication procedure;
receiving, from the mobile device, one or more automatically generated responses for the one or more factors, wherein the one or more responses are automatically generated at the mobile device using a computer learning model based on a current set of parameters for the current multi-factor authentication procedure and a previous set of parameters for a prior multi-factor authentication procedure;
determining, based on a current state of the mobile device received with the one or more automatically generated responses and one or more prior states of the mobile device stored at the server computer system, a risk score for the one or more automatically generated responses; and
generating, based on the risk score, an authorization decision for an authorization request corresponding to the current multi-factor authentication procedure.

2. The non-transitory computer-readable medium of claim 1, wherein determining the risk score is performed by:
inputting the current state of the mobile device into a machine learning model stored at the server computer system.

3. The non-transitory computer-readable medium of claim 1, wherein the determining includes:
determining a similarity value based on comparing the current state of the mobile device and the one or more prior states of the mobile device; and
assigning, based on the similarity value, a risk score to the one or more automatically generated responses.

4. The non-transitory computer-readable medium of claim 1, wherein generating the authorization decision is further based on:
comparing the risk score to a plurality of risk thresholds; and
determining, based on the risk score satisfying a particular risk threshold, whether to escalate the current multi-factor authentication procedure.

5. The non-transitory computer-readable medium of claim 1, wherein the one or more prior states and the current state of the mobile device include:
respective values for types of parameters included in the current set of parameters; and
respective values for one or more of the following types of mobile device parameters: a location, an IP address, and permissions for an account currently logged in on the mobile device.

6. The non-transitory computer-readable medium of claim 1, wherein the current set of parameters and the previous set of parameters include respective values one or more of the following types of parameters: a frequency of login parameter that indicates how often a user of the mobile device logs into a set of one or more accounts and a wearable device parameter that indicates whether a wearable device is being worn by the user of the mobile device and whether the wearable device is unlocked.

7. The non-transitory computer-readable medium of claim 1,
wherein the one or more requests corresponding to the one or more factors are sent to the mobile device based on receiving a response from the mobile device approving or denying a first request in a first multi-factor authentication procedure initiated by the mobile device for a first account; and
wherein the current multi-factor authentication procedure is initiated by another computing device for authentication for a different account than the first account.

8. The non-transitory computer-readable medium of claim 1, wherein the authorization decision indicates, based on the risk score satisfying a particular risk threshold, to disable automated generation of multi-factor authentication responses performed on the mobile device using the computer learning model.

9. The non-transitory computer-readable medium of claim 1, wherein the authorization decision indicates to, based on the risk score satisfying a particular risk threshold:
deny the authorization request corresponding to the current multi-factor authentication procedure; and
transmit, to a system administrator of a risk system, a notification regarding the authorization request, including the risk score for the authorization request.

10. A method, comprising:
sending, by a server computer system to a mobile device, one or more requests corresponding to one or more factors in a multi-factor authentication procedure;
receiving, by the server computer system from the mobile device, one or more automatically generated responses for the one or more factors, wherein the one or more responses are automatically generated at the mobile device using a computer learning model based on a current set of parameters for the multi-factor authentication procedure and a previous set of parameters for a prior multi-factor authentication procedure;
determining, by the server computer system based on a current state of the mobile device received with the one or more automatically generated responses and one or more prior states of the mobile device stored at the server computer system, a risk score for the one or more automatically generated responses; and
generating, by the server computer system based on the risk score, an authorization decision for an authorization request corresponding to the multi-factor authentication procedure.

11. The method of claim 10, wherein determining the risk score is performed by:
inputting the current state of the mobile device into a machine learning model stored at the server computer system, wherein the machine learning model is trained at the server computer system using one or more prior states of the mobile device gathered for one or more prior multi-factor authentication procedures during a particular prior interval of time.

12. The method of claim 10, wherein generating the authorization decision is further based on:
comparing the risk score to a plurality of risk thresholds; and
determining, based on the risk score satisfying a particular risk threshold, whether to escalate the multi-factor authentication procedure.

13. The method of claim 10, wherein the one or more prior states and the current state of the mobile device include:
respective values for types of parameters included in the current set of parameters; and
respective values for one or more of the following types of mobile device parameters: a location, an IP address, and permissions for an account currently logged in on the mobile device.

14. The method of claim 10, wherein the one or more automatic responses received from the mobile device are received for an authorization requested by the mobile device.

15. The method of claim 10, wherein the current set of parameters and previous set of parameters include respective values one or more of the following types of parameters: one or more parameters that indicate personally identifiable information (PII) that is stored on the mobile device that is not shared with other devices, and a wireless signature parameter based on wireless signatures of one or more nearby devices.

16. A system, comprising:
at least one processor; and
a memory having instructions stored thereon that are executable by the at least one processor to cause the system to:
send, to a mobile device, one or more requests corresponding to one or more factors in a multi-factor authentication procedure;
receive, from the mobile device, one or more automatically generated responses for the one or more factors, wherein the one or more responses are automatically generated at the mobile device using a computer learning model based on a current set of parameters for the multi-factor authentication procedure and a previous set of parameters for a prior multi-factor authentication procedure;
determine, based on a current state of the mobile device received with the one or more automatically generated responses and one or more prior states of the mobile device stored at the system, a risk score for the one or more automatically generated responses; and
generate, based on the risk score, an authorization decision for an authorization request corresponding to the multi-factor authentication procedure.

17. The system of claim 16, wherein determining the risk score is performed by:
inputting the current state and the one or more prior states of the mobile device into a machine learning model stored at the system, wherein the machine learning model is trained at the system using one or more prior states of the mobile device gathered for one or more prior multi-factor authentication procedures during a particular prior interval of time during a particular prior interval of time.

18. The system of claim 16, wherein generating the authorization decision is further based on:
comparing the risk score to a plurality of risk thresholds; and
determining, based on the risk score satisfying a particular risk threshold, whether to escalate the multi-factor authentication procedure.

19. The system of claim 16, wherein the one or more prior states and the current state of the mobile device include:
respective values for types of parameters included in the current set of parameters; and
respective values for one or more of the following types of mobile device parameters: a location, an IP address, and permissions for an account currently logged in on the mobile device.

20. The system of claim 16, wherein the current set of parameters and the previous set of parameters include respective values one or more of the following types of parameters: a frequency of login parameter that indicates how often a user of the mobile device logs into a set of one or more accounts and a wearable device parameter that indicates whether a wearable device is being worn by the user of the mobile device and whether the wearable device is unlocked.
